(19) United States
(12) Patent Application Publication
(10) Pub. No.: US 2025/0284541 A1
(43) Pub. Date: Sep. 11, 2025

(54) INTER-FRAME FEATURE MAP COMPRESSION FOR STATEFUL INFERENCE

(71) Applicant: Snap Inc., Santa Monica, CA (US)

(72) Inventors: Cornelis Hermanus van Berkel, Heeze (NL); Thomas Gerbert Steenbruggen, Eindhoven (NL); Luc Johannes Wilhelmus Waeijen, Haelen (NL); Zeqi Zhu, Eindhoven (NL)

(21) Appl. No.: 18/601,593

(22) Filed: Mar. 11, 2024

(51) Int. Cl. G06F 9/50; G06N 5/04

(52) U.S. Cl. CPC G06F 9/5022; G06N 5/04

(57) ABSTRACT

Examples described herein relate to stateful inference of a neural network. A plurality of feature map segments each has a first set of values stored in a compressed manner. The first sets of values at least partially represent an extrinsic state memory of the neural network after processing of a previous input frame. Operations are performed with respect to each feature map segment. The operations include decompressing and storing the first set of values. The operations further include updating at least a subset of the decompressed first set of values based on a current input frame to obtain a second set of values. The second set of values is compressed and stored. Memory resources used to store the decompressed first set of values is released. The second sets of values at least partially represent the extrinsic state memory of the neural network after processing of the current input frame.

### TECHNICAL FIELD

The subject matter disclosed herein relates to neural network processing. More specifically, but not exclusively, the subject matter relates to techniques for reducing memory footprint in stateful inference of neural networks, and for reducing memory accesses therein to lower energy consumption.

### BACKGROUND

Neural networks are commonly used to process data. For example, neural networks are often used in the processing of image data or video data for tasks such as object detection and object tracking. In many applications, inference of a neural network involves a function with a frame as input and a frame as output. Inference may be applied to a sequence of input frames, resulting in a sequence of output frames. A sequence of input frames can, for example, consist of image data (e.g., two-dimensional (2D) arrays of pixel values in video processing applications) or audio samples (e.g., one-dimensional (1D) windows on a stream of audio in audio processing applications).

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic illustration of a processing system, according to some examples.

FIG. 2 is a diagrammatic illustration of operation of a stateful neuron, according to some examples.

FIG. 3 is a diagrammatic illustration of operation of a stateful neuron that includes compression and decompression, according to some examples.

FIG. 4 is a flowchart illustrating operations of a method suitable for reducing memory footprint in stateful inference of a neural network, according to some examples.

FIG. 5 is a diagrammatic illustration of block floating point (BFP) conversion that may be performed as a compression technique by a processing system during stateful inference, according to some examples.

FIG. 6 is a diagrammatic illustration of a block assignment technique for BFP compression of feature map values, according to some examples.

FIG. 7 is a diagrammatic illustration of a block assignment technique for BFP compression of feature map values, according to some examples.

FIG. 8 is a diagrammatic illustration of an extended reality (XR) device that includes a processing unit that is configured to process a neural network, according to some examples.

### DETAILED DESCRIPTION

Many neural networks, including convolutional neural networks (CNNs), consist of a collection of interconnected layers, where each layer includes a set of feature maps. A feature map is, for example, a 1D or 2D array of values, similar to an input frame that is fed into the neural network. Feature maps may represent intermediate results of an inference function. The value of a particular feature map element may depend on values of feature map elements of one or more preceding layers of the neural network.

The term “frame,” as used herein in the context of inputs to a neural network, refers to a unit or set of data that represents a snapshot within a sequence of such units or sets. The snapshots may be captured or sampled over time. In the context of image processing, for example, a frame typically provides a single image or a portion of visual content from a video stream. For audio processing, a frame may represent a segment of audio data, such as a time-sliced sample of a continuous audio signal. A frame may capture the state of an input signal at a specific point in time and can thus be used as the basis for sequential processing in temporal analysis. Frames may be non-overlapping, where each frame is distinct and separate from the others, or overlapping, where frames share common data points with preceding or subsequent frames (e.g., to preserve continuity in the temporal domain). In the context of the present disclosure, “frames” (e.g., input frames of a neural network) are not limited to visual or auditory data but can extend to other time-ordered sequences of data that a neural network processes.

Stateless inference and stateful inference are two different approaches to neural network processing. In stateless inference, output produced by the neural network typically depends only on the most recent input. For example, a given output frame is generated based only on the latest input frame, without considering data from input frames prior to the latest input frame. In the case of stateful inference, on the other hand, a given output frame depends not only on the latest input frame but also on prior input frames. To allow for stateful inference, this dependence is captured or retained within the neural network, and is referred to as the “state” or “state memory” of the neural network.

The term “stateful inference,” as used herein, thus refers to inference performed by a neural network in which the neural network is able to maintain, update, and utilize a persistent state across input frames. In stateful inference, the neural network retains information from one or more previous frames and uses this information to influence the processing of subsequent frames. Stateful inference can allow a neural network to exhibit temporal coherence and to make predictions that are, for example, contextually informed by the history of received data. In contrast, the term “stateless inference” refers to a process of executing a neural network where the output for each input frame is determined independently of other input frames. For example, in stateless inference, the neural network does not retain information about previous inputs when processing a current input, and may reset its state for each new frame.

State memory may be either an “intrinsic state memory” or an “extrinsic state memory.” An intrinsic state memory includes a representation or set of values that functionally contributes to the output of the neural network. This type of state memory is utilized, for example, in recurrent neural networks (RNNs) and long-short term memory (LSTM) architectures. Intrinsic state memory is used to retain information across different stages of input processing, thereby contributing directly to the output of the network. Intrinsic state memory may thus be referred to as “functional” state memory. For example, in a RNN that processes a sentence one word at a time, the intrinsic state memory allows the RNN to “remember” context provided by previously processed words. In contrast, extrinsic state memory refers to non-functional memory in the form of a representation or set of values that is captured to exploit temporal sparsity (as described further below) between frames. The extrinsic state may not functionally contribute to network operations. Instead, it may be external to network processing operations and added (e.g., “remembered” during processing) to reduce the amount of compute, thereby reducing power consumption or latencies, or increasing throughput. Extrinsic state memory may thus be referred to as “supplementary” state memory as it is used to enhance performance by storing intermediate representations of the network. For example, in a video processing application, extrinsic state memory may include values used to store the state of the network that corresponds to the static background across consecutive frames, thereby allowing the network to focus computational resources only on the segments of the input that exhibit significant changes over time.

While a number of examples described herein relate to external state memory, it is noted that one or more aspects of the present disclosure may also be applied to internal state memory.

Referring again to stateful inference, stateful inference therefore requires the storing of details of the state of the neural network. As a result, a relatively large memory footprint may be needed to perform stateful inference in an effective manner. This may have an adverse impact on system performance or restrict the feasibility of stateful inference, particularly in environments with limited memory resources, such as in wearable, mobile, or edge devices. Accordingly, it may be desirable to reduce the memory footprint associated with performing stateful inference.

In stateful inference, each application of an inference function may produce an output frame that is a function of both the latest input frame and the state of the neural network. Each inference may also update the state of the neural network. This approach is particularly useful for tasks where a temporal relationship between consecutive frames carries meaningful information that is important for accurate processing, such as in time-series prediction, video analysis, or audio processing.

Updating the state memory of the neural network may involve updating the values in its feature maps. In some implementations, only a subset of the feature map values is updated. For example, in so-called “sparse” inference, a processor may be designed or configured to leverage the concept of “temporal sparsity” by only making updates to values where changes (or meaningful changes) between frames are detected. For example, a surveillance camera filming a quiet area will have many similarities between successive captured images, meaning that its signal is temporally sparse. In some cases, only significant changes over time are propagated through the neural network such that insignificant changes do not cause redundant or unnecessary computations. For example, it may be sufficient to process only a first frame as a whole, while consecutive frames can be reduced to a “delta” state (e.g., “current state” minus “previous state” equals “delta state”) for processing purposes.

In any event, stateful inference may require storing of the previous state of the network to enable use of the previous state in determining the current state, updating the previous state, or determining the delta state. The state of the neural network may, for example, be stored in memory, such as on-chip in static random access memory (SRAM), or off-chip in synchronous dynamic random access memory (SDRAM).

Storing the state of the neural network may require a relatively large memory footprint, making stateful inference potentially costly (e.g., in terms of die area in the case of SRAM, or memory traffic in the case of SDRAM). Examples described herein enable a reduction in the amount of memory used for storing the state of the neural network. Techniques described in the present disclosure utilize data compression to reduce an overall memory footprint. Techniques described herein also reduce memory accesses needed in stateful inference, thereby lower energy consumption.

In some examples, when the state memory, as represented by feature maps, is compressed, the feature maps must be decompressed prior to the updating of their values (or at least a subset of their values). Examples described herein perform such a process in a segment-wise manner. A feature map segment may, for example, be one or more rows (or columns) of a 2D feature map array, or an entire feature map array.

Accordingly, in some examples, segment-wise compression of feature map segments is performed between successive frames. Compression may be lossless or lossy, and examples of compression techniques are described herein. During inference, a sequence of actions may be applied to feature map segments of respective feature maps (e.g., to all corresponding feature map segments of a given layer). The sequence may, for example, comprise (1) reading compressed feature map segment values from compressed memory resources, (2) applying a decompress function and storing the decompressed feature map segment values in temporary uncompressed memory resources, (3) applying updates to at least some of the values of the decompressed feature map segments in the uncompressed memory resources, (4) reading updated values (and optionally applying an activation function), (5) compressing the feature map segments and storing the compressed feature map segments in the compressed memory resources, and (6) releasing the temporary uncompressed memory resources used for the decompressed feature map segment values. It is noted that, in some examples, the “uncompressed” memory resources and the “compressed” memory resources refer to logical memories. These memories may or may not be mapped on the same physical memory, and memory allocation may be static or dynamic.

Feature map values may be scalar values or composites of scalar values. These scalar values can, for example, be integers, floating-point values, or fixed-point values. One example form of compression is to perform the uncompressed calculations, such as convolution or accumulation, in 32-bit floating point (FP32), and to store the feature map segments in 16-bit floating point (FP16). Another example form of compression is to perform the uncompressed calculations in floating point (e.g., 32-bit or 16-bit) and to store the feature map segments using block floating point (BFP) format.

An example method for reducing memory footprint in stateful inference of a neural network may include accessing a plurality of feature map segments. Each feature map segment comprises a first set of values stored in a compressed manner. The first sets of values at least partially represent a state memory of the neural network after processing of a previous input frame. In some examples, the state memory is an extrinsic state memory. Alternatively, the state memory may be an intrinsic state memory.

For each feature map segment of the plurality of feature map segments, the method may include decompressing the first set of values, storing the decompressed first set of values, and updating at least a subset of the decompressed first set of values based on a current input frame to obtain a second set of values. The method may further include compressing the second set of values, storing the compressed second set of values, and releasing memory resources used to store the decompressed first set of values.

When considered together, the second set of values obtained in this manner for each feature map segment may then at least partially represent the state memory of the neural network after processing of the current input frame. The neural network may include a plurality of feature maps, with each feature map including a plurality of the feature map segments. In some examples, the values to be stored to represent the state memory (e.g., the first set of values and the second set of values) are compressed using BFP. Memory savings may result from a combined effect of sharing a common exponent among some or all values in the feature map segments (e.g., neighboring values) and a reduction in the number of mantissa bits used for such values.

In some examples, blocks used in BFP are chosen such that they are non-overlapping and together fill an entire feature map. Blocks may, for example, extend over a range of successive values in a row, or across a number of rows and a number of columns. By varying the chosen number of mantissa bits, memory savings can be traded versus accuracy loss. The number of mantissa bits may be different for different feature maps or for different layers of the neural network. Furthermore, the parameters of the blocks (e.g., shapes and/or sizes) may be varied across different feature maps or different layers.

Accordingly, where the neural network comprises a plurality of layers, first compression parameters (e.g., details of blocks and bits) applied to feature map segments of the plurality of feature map segments that are in a first subset of the plurality of layers may differ from second compression parameters (e.g., details of blocks and bits) applied to feature map segments of the plurality of feature map segments that are in a second subset of the plurality of layers. In some examples, where each feature map comprises one or more of the plurality of feature map segments, first compression parameters applied to feature map segments of the plurality of feature map segments that are in a first subset of the plurality of feature maps differ from second compression parameters applied to feature map segments of the plurality of feature map segments that are in a second subset of the plurality of feature maps.

One or more processors performing the method may be configured to reset the state memory (e.g., extrinsic state memory) of the neural network in response to detecting a reset trigger. For example, quantization resulting from a reduction of the number of mantissa bits may have an impact on inference accuracy (depending on the inference algorithm). In order to limit possible accumulated errors, the state memory of the neural network may be reset responsive to the reset trigger. For example, the one or more processors may periodically reset the state memory using a time-based reset trigger or a reset trigger may be provided after a predetermined number of inferences. The reset trigger may thus be a specific number of inferences (e.g., since a last reset), examples of which are described herein.

In some examples, the updating performed based on the current input frame to obtain the second set of values comprises applying accumulations that result from the current input frame, with the accumulations being determined based on differences between the current input frame and the previous input frame. Accordingly, the updating may involve updating feature map values based on a sparse inference approach where a delta state is used to update the state memory of the neural network. For example, in event-based processing, accumulation based on the current input frame is only performed if an event is detected for a neuron corresponding to a feature map value. In some examples, prior to the compression and/or storage of the second set of values, an activation function is applied to one or more values in the second set of values.

The frames, such as the previous input frame and the current input frame, may be image data frames or audio data frames. Feature map segments of each feature map may be respective zones within the feature map. The feature map may be divided into zones based on a predetermined segmentation rule. For example, as mentioned above, feature map segments may be respective rows or columns in the feature map. The segment-wise updating may thus, for example, be carried out in a row-by-row or column-by-column manner for each feature map.

As mentioned, when considered together, the second set of values for each feature map segment, generated based on the current input frame, may represent an updated state memory of the neural network. The updated state memory may then be used in processing of a subsequent input frame. For example, for each feature map segment of the plurality of feature map segments, the method may further include decompressing the second set of values associated with the feature map segment, storing the decompressed second set of values, and updating at least a subset of the decompressed second set of values based on the subsequent input frame to obtain a third set of values. The method may further include compressing the third set of values, storing the compressed third set of values, and releasing memory resources used to store the decompressed second set of values. When considered together, the third set of values for each feature map segment may then at least partially represent the state memory of the neural network after processing of the subsequent input frame. The method may continue in a similar manner for further input frames.

Techniques described herein may be implemented using different types of processing systems. A processing system may include one or more processors configured to perform operations as described herein. In some examples, the one or more processors comprise an event-based neural processor that has a plurality of processing clusters configured to process at least a subset of the feature map segments in parallel. One or more processors implementing techniques described herein may thus provide an accelerator that leverages temporal sparsity and also utilizes memory resources in an efficient manner.

Example techniques described herein may be implemented by a computing device. The computing device may include a processing system as discussed above. The computing device may be an XR device, such as an augmented reality (AR) or virtual reality (VR) device, that includes the processing system as discussed above.

The XR device may further include an optical device communicatively coupled to the processing system. The XR device may be configured to capture image frames using the optical device and process, using the processing system, the image frames as described herein. The XR device may include an audio capture device, such as a microphone, communicatively coupled to the processing system. The XR device may be configured to capture audio signals using the audio capture device and process, using the processing system, frames of an audio signal as described herein. The XR device may apply temporal sparsity techniques and compression techniques described herein to reduce overall memory footprint and/or computational load associated with processing a neural network.

Example methods for processing a neural network may be performed for each of a plurality of feature map segments in the neural network. Accordingly, while some descriptions herein focus on operations performed with respect to a single feature map segment, it will be appreciated that similar operations may be performed to process multiple feature map segments within the neural network, at least some of which may be processed in parallel.

As mentioned, techniques described herein may be applied for computationally efficient image processing (e.g., in machine learning applications such as object detection or object tracking) or audio processing (e.g., in machine learning applications such as command detection). While image processing and audio processing are example applications of the present disclosure, techniques described herein may be applied to other types of data (e.g., to feature maps that do not represent image or audio features). For example, techniques described herein may be utilized for computationally efficient processing of time series data tables or other inputs that, for example, can be transformed into a matrix format and that have a temporal component. Accordingly, unless otherwise specified herein, a feature map referred to in this disclosure does not necessarily relate to a feature map that represents an image data frame (or features of the image data frame) or an audio data frame (or features of the audio data frame).

Furthermore, techniques described herein may be applied to various types of feature maps, and are not limited to feature maps of specific shapes or dimensions. For example, it is noted that feature maps may be multi-channel feature maps and operations in the method may be performed for each channel and/or each segment in a channel, or even across channels.

Examples described herein may thus perform decompression, updating, and compression in a segment-wise manner. Techniques described herein may provide one or more technical benefits. For example, by updating segments of a feature map rather than an entire feature map at the same time, a processing system may reduce the amount of memory resources required at any given time. Segment-wise updates may also allow for a higher degree of parallel processing of data, and may make inference more scalable by breaking, for example, large feature maps into smaller, more manageable segments. These features may, in turn, allow for or result in reduced latency. For example, a processing system may start to perform computations on later segments while earlier segments are still being prepared or finalized, thereby reducing latency while retaining memory benefits associated with segment-wise data handling.

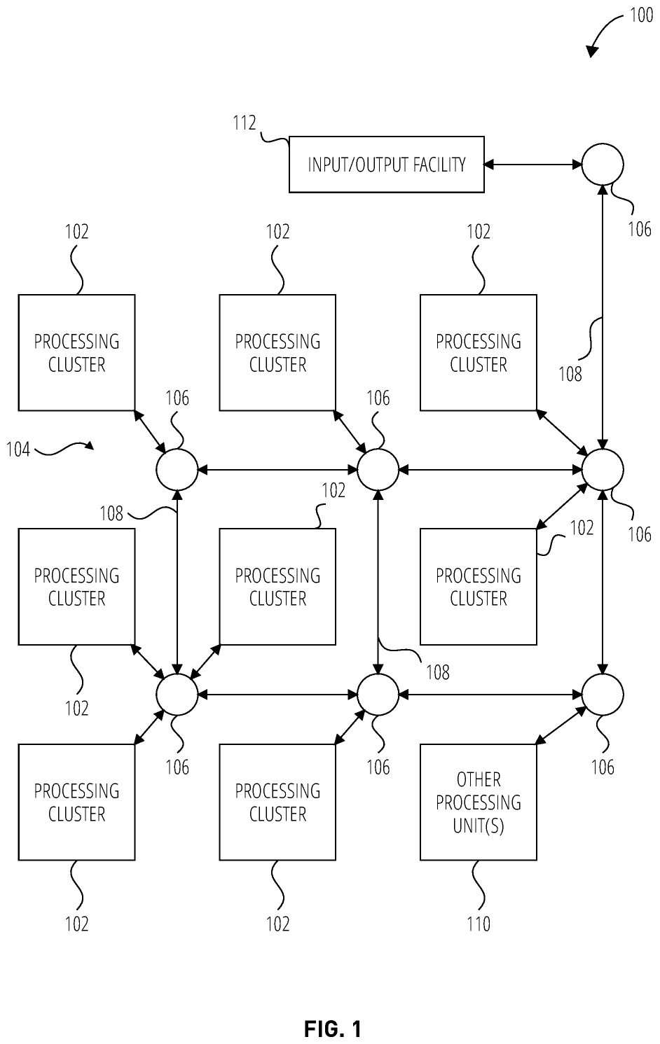

FIG. 1 illustrates a processing system 100 according to some examples. The processing system 100 is configured for event-based processing tasks. In some examples, the components of the processing system 100 are integrated into a single processing unit (e.g., a Neural Processing Unit). For example, the processing system 100 may be implemented as a Neural Processing Unit in an Application-Specific Instruction Processor (ASIP) designed to facilitate inference on edge-of-cloud devices.

The processing system 100 includes a plurality of processing clusters 102, which are interconnected by a network 104. The network 104 functions as a message exchange network for exchange of messages, including event messages, instruction messages, configuration messages, or other messages, depending on the implementation. Messages may thus include instructions to perform computations, configuration instructions, or other data.

The network 104 includes nodes 106 forming an interface with respective processing clusters 102 and links 108 between the nodes 106. Processing units of one or more other types, such as one or more other processing unit(s) 110 as shown in FIG. 1, may also be included in the processing system 100 and coupled to the network 104. For example, the one or more other processing unit(s) 110 may include a digital signal processor, general purpose processor (e.g., a Central Processing Unit (CPU)), host processor, or Graphics Processing Unit (GPU).

In some examples, each processing cluster 102 has a message receiving facility to receive event messages via the network 104 and a message transmitting facility to transmit event messages via the network 104. Each of the processing clusters 102 may include one or more processing elements (not shown). Each processing element may be a neural processing element that, in the context of neural network processing, mimics the behavior of a biological neuron (at least to some extent), as is described further below.

Each of the processing clusters 102 may include its own local memory or cache, allowing for rapid data access. For example, a neuromorphic state memory may store values representative of a neuromorphic state associated with one or more processing elements. Processing elements may have their own respective memory storing their state or other information, or each processing cluster 102 may have a memory that stores state or other information for multiple processing elements.

In some examples, each processing cluster 102 has its own static random access memory (SRAM) (e.g., 256 kB of SRAM). Neuromorphic states may be calculated using, for example, FP32 or FP16.

The processing system 100 may further include an input/output facility 112 that is configured to receive input data and transmit output data. The input/output facility 112 may also selectively map messages. As a result, the processing clusters 102 may not only transmit messages directly, but may also have their messages indirectly redirected and broadcast via the input/output facility 112. For example, the input/output facility 112 can be configured to receive messages with message content and determine the destination of each respective message (e.g., using a mapping function and/or an element address and/or data values in the messages).

Different processing clusters 102 may be configured for different tasks. For example, some clusters may be dedicated to performing basic arithmetic computations, some clusters may be dedicated to neuromorphic computations, and other clusters may be dedicated to performing complex mathematical operations. In some examples, the processing clusters 102 are configured to perform neural network processing, while the one or more other processing unit(s) 110 perform other computational tasks. Alternatively or additionally, processing clusters may be provided that are capable of being reconfigured to perform one of various classes of operations. Likewise, a processing cluster may have a plurality of processing elements that may have the same functionality or different functionalities, or may be reconfigured to have a particular functionality.

Each processing element may be designed or configured to detect and generate event messages based on specific computational rules (e.g., spike when a threshold is exceeded). Neuromorphic states may be dynamically updated based on received event messages and computations performed within a processing cluster 102. In some examples, if the value of a neuromorphic state approaches or exceeds a threshold potential, the corresponding processing element can issue a control signal, prompting the message transmitting facility to send out one or more event messages (e.g., to other processing clusters 102 in the processing system 100).

The processing system 100 can be employed in various applications, such as image processing, audio processing, machine learning, pattern recognition, or real-time data analytics. For example, in an image processing application, the processing clusters 102 may be utilized to perform convolutional operations on image data, while another processing unit (e.g., the other processing unit(s) 110) may handle tasks such as image rendering or video encoding.

The processing system 100 may efficiently handle layer-by-layer processing in a neural network context. As described in greater detail below, the processing system 100 may utilize the processing elements in the processing clusters 102 to perform convolution operations that involve applying kernels, or filters, over input data (e.g., image data) to create feature maps. The processing elements may also apply other operations, such as activation functions. In some examples, different layers of the neural network may be assigned to different subsets of the processing clusters 102 for efficient execution.

Deep neural networks (e.g., CNNs) comprise a plurality of neural network layers. Each neural network layer typically includes a plurality of neural network computation elements. Neural network computation elements in a layer may receive weighted inputs from neural network computation elements in a preceding layer or an input device and in turn may have outputs to neural network computation elements in a succeeding layer. The specific way in which a neural network layer is connected to a preceding layer depends on its type. By way of example, in a fully-connected layer, each neural network computation element may receive an input from a neural network computation element in a preceding layer. In a convolutional layer, each neural network computation element may receive an input from a neural network computation element of a preceding layer that is within the range of a convolution kernel centered around a local address corresponding to a local address in the convolutional layer. A pooling layer is used for a spatial dimension reduction. Respective neural network computation elements of a pooling layer correspond to respective sets of neural network computation elements in the preceding layer. A pooling operation for a respective neural network element of a pooling layer, for example, involves selecting a value from its respective set of neural network elements in the preceding layer, such as sampling a maximum value, a minimum value, a median value, or a value of a specific one of the respective set of neural network elements. Alternatively, the pooling operation involves computing the average value from the respective set of neural network elements in the preceding layer.

An event-based or message-based processing system, such as the processing system 100, can be configured as a deep neural network. In such cases, at least some of the processing elements of the processing clusters 102 are configured as neural network computation elements that may function as described above. In some examples, the processing elements may be provided as dedicated hardware that function as neural network computation elements. In other examples, this can be achieved by configuring the processing system 100 such that the processing elements are programmable to function as neural network computation elements. In some examples, each processing element has a dedicated processor, while in other examples, the processing elements of a processing cluster 102 share a processor. In operation, the processing elements of the processing clusters 102 may thus, when configured or functioning as neural network elements, receive input messages and transmit output messages via the network 104.

In some examples, each processing cluster 102 functions as a neuron core. Each processor cluster 102 may be configured to operate using single instruction, multiple data (SIMD) processing. For example, each processing cluster 102 may be configured to perform a single instruction on four data inputs in parallel.

In some examples, since each processing cluster 102 has its own processing capabilities and memory, it is possible to scale the neuron capacity of the processing system 100 to create a mesh network-on-chip (NOC) of neuron cores of a desired size, capacity, or performance.

When processing a neural network, the processing system 100 implements event-based processing. For example, a neuron activation is only propagated through the network 104 if its value constitutes an “event” (e.g., a value is non-zero or exceeds a threshold value). The processing system 100 therefore exploits sparsity by, for example, only considering certain values as “events.” Since only active neurons transmit data, when compared to a conventional architecture that may process all neuron values, this reduces the volume of data that needs to be processed and transferred, enhancing efficiency.

The processing system 100 may leverage temporal sparsity in performing stateful inference in one or more applications, such as in video processing or audio signal processing, as described in more detail elsewhere. The processing system 100 may exploit temporal sparsity by leveraging correlations in network inputs over time. To be able to perform stateful inference, including stateful inference that leverages temporal sparsity, a state of the neural network must be stored to allow the processing system 100 to keep track of the state of the neural network between frames. Values stored for this purpose may thus represent a “state memory” of the neural network. Examples described herein reduce the memory footprint associated with stateful inference by utilizing a compression scheme.

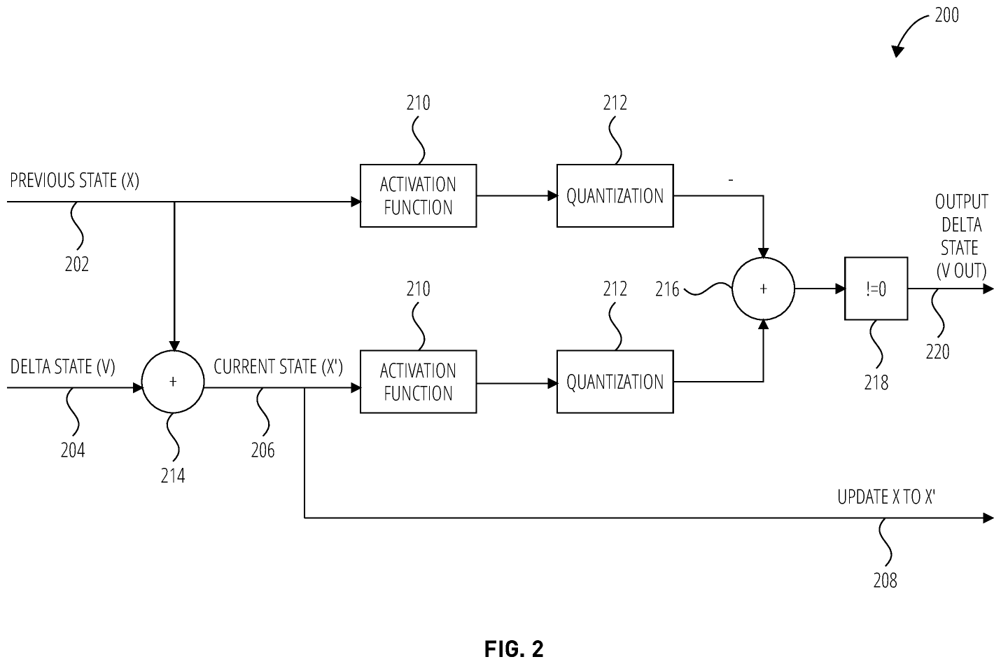

FIG. 2 is a diagram 200 illustrating operation of a stateful neuron, according to some examples. The stateful neuron is configured to process input data, spike if triggered, and update its internal (e.g., neuromorphic) state in a manner that accounts for temporal dependencies between sequential data frames. For example, the stateful neuron in the diagram 200 may be provided by a processing element within one of the processing clusters 102 of FIG. 1.

In stateful inference, for stateful neurons to calculate a delta state, a record of a previous state 202 may be kept in memory. The previous state 202 represents retained information from processing of a previous frame. If an event occurs for a certain neuron, this neuron receives a delta state 204. The delta state 204 is then used to construct a current state 206 by adding the delta state 204 to the previous state 202 during accumulation operation 214. The current state 206 reflects new information introduced based on a current frame while maintaining continuity with past information.

In some examples, the previous state 202 and the current state 206 are used to calculate an output delta state 220 by first passing them to an activation function 210 of the neuron. After the activation function 210, quantization 212 of the previous state 202 and the current state 206 may be performed. The quantization 212 may act as threshold for temporal sparsity. For example, depending on the intensity of the quantization 212, it removes a certain degree of differences between the current state 206 and the previous state 202 that are regarded as insignificant. If, after applying the activation function 210 and quantization 212, the current state 206 differs from the previous state 202, then it means that the received difference has pushed the previous state 202 into a different quantization level.

For example, and as shown in FIG. 2, if, after accumulation operation 216 it is determined, at check operation 218, that the difference is a non-zero difference, then the output delta state 220 is generated. Thus, the neuron spikes and the output delta state 220 can be sent to one more subsequent neurons. For example, in the context of the processing system 100 of FIG. 1, it is determined that the neuromorphic state of the neuron has reached or exceeded a threshold potential, causing the processing element functioning as the neuron to issue a control signal (e.g., the output delta state 220). A message transmitting facility may then send out an event message (e.g., to one or more other processing elements or clusters). On the other hand, if there is no difference, the neuron does not spike and no delta output is propagated forward through the neural network, thereby reducing computations.

In some examples, the previous state 202 is updated in a state update operation 208 irrespective of whether the neuron has spiked or not, to ensure the correctness of calculated output delta states. The state update operation 208 may involve storing the current state 206 in memory. In some examples, the previous state thus needs to be updated and kept in memory over time. This allows the “latest” previous state to be used for each new inference of an incoming frame.

It will be appreciated that similar operations may be performed at a large number of neurons at the same time. The state of a neuron may correspond to one or more values of a feature map. Accordingly, a large number of neurons may each operate as shown in the diagram 200 to process feature map values and update the feature map values to reflect the state or state memory of the neural network. For example, the current state 206 of the neuron shown in the diagram 200 may correspond to a value within a particular feature map of a particular layer of the neural network. The current states of all neurons may then represent the current state or current state memory of the neural network.

This process enables processing of a neural network to perform stateful inference, which may be efficient or useful in applications involving sequential data, such as video or audio stream processing. However, as mentioned, the additional memory cost of stateful inference may be undesirable. For example, the requirement to store the state of a neuron (e.g., a current feature map value) each time inference is performed may limit the size of a neural network that is able to fit on a Neural Processing Unit comprising the processing system 100.

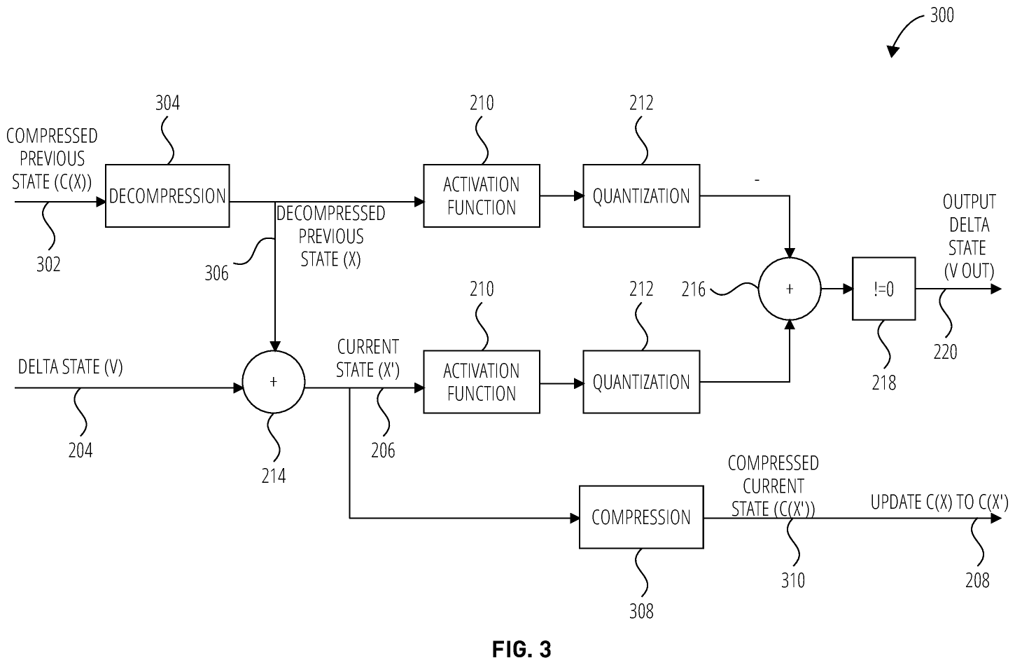

FIG. 3 is a diagram 300 illustrating operation of a stateful neuron, according to some examples, in which state information is compressed and decompressed to reduce memory footprint. Some items or operations shown in the diagram 300 are similar to those shown in the diagram 200 of FIG. 2, and like reference numerals refer to like items or operations.

In the diagram 300, it is shown that the previous state of the neuron is stored as a compressed previous state 302. A decompression operation 304 is performed to obtain a decompressed previous state 306 prior to the accumulation operation 214 to obtain the current state 206 based on the delta state 204 and the decompressed previous state 306.

The decompressed previous state 306 and the current state 206 are used to calculate an output delta state 220 by first passing them to an activation function 210 of the neuron. After the activation function 210, quantization 212 of the decompressed previous state 306 and the current state 206 may be performed. For example, and as shown in FIG. 3, if, after accumulation operation 216 it is determined, at check operation 218, that a difference between the decompressed previous state 306 and the current state 206 is a non-zero difference, the output delta state 220 is generated, as described in greater detail above.

The neuron of the diagram 300 of FIG. 3 operates to update the current state 206 in a state update operation 208 irrespective of whether the neuron has spiked or not. However, the neuron of FIG. 3 first compresses the current state 206 in compression operation 308 to obtain a compressed current state 310. The compressed current state 310 may be stored in memory instead of storing uncompressed information. This reduces the memory requirements associated with retaining state information.

For example, instead of both performing updates on an FP16 value and storing the updated FP16 value in SRAM to represent a neuromorphic state, the value may be compressed prior to storage (e.g., converted to BFP). In other words, the neuromorphic states (e.g., feature map values) may be stored in a format that uses fewer bits than the representations of the values which are used to perform updates (e.g., accumulation, applying an activation function, and determining whether to spike). Different techniques may be used to compress neuron states, and examples are discussed elsewhere. A decompress function (e.g., converting from BFP back to FP16) may then be performed when performing updates while processing a subsequent input frame.

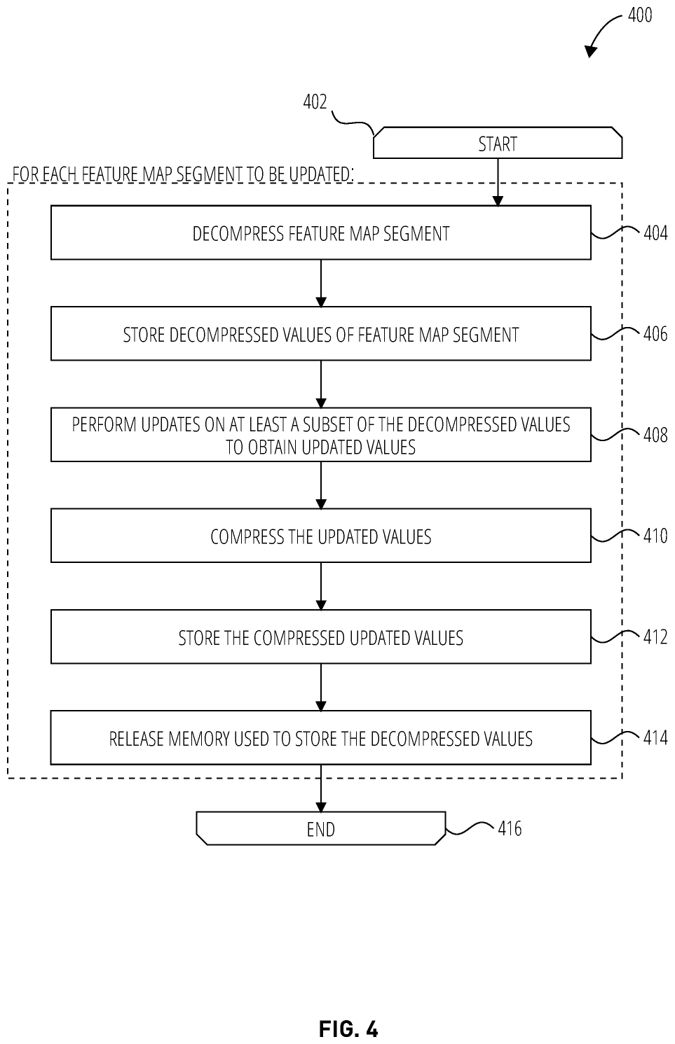

FIG. 4 is a flowchart illustrating operations of a method 400 suitable for reducing memory footprint in stateful inference of a neural network, according to some examples. By way of example and not limitation, aspects of the method 400 may be performed by a computing device equipped with the processing system 100 of FIG. 1, or components thereof. Accordingly, the processing system 100 is used as an example in the description of FIG. 4 below. However, the processing system 100 is a non-limiting example of a system that can perform the method 400, and it will be appreciated that the method 400 may also be performed using one or more other systems, processors, devices, or architectures.

The computing device may, for example, be a personal computing device, a server, a shared computing node, an edge device, or another device, such as an XR device. The computing device uses the processing system 100 to process consecutive input frames through a neural network. For example, in the case of video processing, the neural network may be used for object detection or object tracking. The neural network may, for example, be a CNN or a spiking neural network. In the method 400 of FIG. 4, operations are applied with respect to an extrinsic state memory of the neural network. However, it is noted that one or more operations described herein could also be applied to an intrinsic state memory of a neural network in other examples.

In the method 400 of FIG. 4, updates to feature maps in a neural network are performed in a segment-wise manner. In many cases, a neural network comprises multiple layers and multiple feature maps in each layer. Feature maps may be divided into zones based on a predetermined segmentation rule to obtain feature map segments. For example, each feature map segment in a feature map may be a respective row or a respective column thereof, or a respective block covering a number of rows and columns. However, it will be appreciated that feature maps may be segmented in various other ways.

In a CNN, for example, an incoming neural event can affect multiple neighboring segments. This number may depend on the size of the segment and on the size of the convolution kernel. A computing device may schedule incoming neural events such that synchronization signals can be used to manage “active” segments, including opening (claiming memory for decompressed segments) and closure (release of a segment).

Larger segments may need more memory, but allow for relatively more efficient processing and synchronization. Smaller segments may have larger overheads for processing and synchronization, but need less memory. A computing device may be configured to manage this trade-off based on the network and/or resources available.

The feature map segments in a feature map may be handled in a sequence. Such segment-wise handling may enhance the efficiency of the updating process.

In some examples, individual segments of a feature map may be processed in parallel. For example, in the processing system 100 of FIG. 1, if a feature map is split and mapped onto two or more cores, such parallel processing may occur.

At the start of the method 400, the feature map segments within the neural network each include values that are stored in a compressed format. Each of the values may be a respective value in a respective feature map. The values of the feature map segments, when considered as a whole at the start of the method 400, represent the extrinsic state memory of the neural network after processing of a previous input frame. This extrinsic state memory is used to enhance performance by exploiting temporal sparsity, as described elsewhere herein.

The method 400 commences at opening loop element 402, and proceeds to operations 404 to 414. As indicated in broken lines in FIG. 4, operations 404 to 414 are performed for each respective feature map segment of a plurality of feature map segments. Accordingly, while the description of operations 404 to 414 below is provided for one feature map segment, it will be appreciated that similar operations may be performed on other feature map segments. It will also be appreciated that, in some cases, certain feature map segments in a neural network will not be updated (e.g., when there is no “delta state” to apply), in which cases operations 404 to 414 are applied only to a subset of feature map segments within the neural network. For example, as mentioned, in event-based processing, accumulation based on a current input frame is only performed if an event is detected for a neuron corresponding to a feature map value.

At operation 404, the processing system 100 decompresses the stored feature map segment. For example, the values of the feature map segment, that were generated during inference of a previous input frame, may be converted to BFP format to reduce memory footprint, and stored in memory, and then decompressed by converting them back to FP16 format. The values may be retrieved from compressed memory resources, as described below.

The decompressed values of the feature map segment are stored in uncompressed memory resources at operation 406. For example, the decompressed values may be stored in on-chip memory of a processing cluster 102 of the processing system 100 to enable quick retrieval. At operation 408, the processing system 100 updates at least a subset of the decompressed values to obtain updated values. For example, referring to the diagram 300 of FIG. 3, one or more of the values may be updated using a delta state 204 resulting from a current input frame being processed by the neural network.

The method 400 may, for example, include initializing the uncompressed memory resources with the decompressed values obtained in operation 404, and then, after initializing the uncompressed memory resources with those values, applying one or more accumulations that result from the current input frame at operation 408 (e.g., applying delta state values to update each value that needs to be updated). Alternatively, the method 400 may include initializing the uncompressed memory resources with zero values, then applying, to the zero values, one or more first accumulations that result from the current input frame (e.g., applying the delta state values), and then, after applying the one or more first accumulations, applying one or more second accumulations based on the decompressed values obtained in operation 404.

Operation 408 may yield a set of updated values in which at least a subset of the values differ from the values that were originally obtained through decompression. These updated values are updated state values reflecting changes brought about by the current input frame being processed by the neural network. The updated values are then compressed at operation 410 (e.g., by converting them to BFP format). The compressed updated values are stored in the compressed memory resources at operation 412. For example, the compressed memory resources may also be on-chip memory of the processing cluster 102 of the processing system 100, facilitating quick retrieval for processing of subsequent input frames. The uncompressed memory resources used to store the decompressed values (operation 406) can then be released at operation 414.

In some examples, memory resources may be managed based on dependencies between segments (e.g., lines) of feature maps. For example, the computation of a particular segment can only be started based on the completion of a specific “earlier” segment of that feature map. This bounds the number of live segments in the system, and therefore the amount of storage space that is required. The completion of a segment signals that the associated memory can be freed, and be used by a next segment. These events signal to a segment that it may start, effectively releasing the memory allocated to a previous segment, and reallocating it to the newly started one. The granularity of such dependencies may be changed. For example, a segment may be a full line, but could also be defined as a smaller or larger unit.

In the context of the processing system 100 of FIG. 1 operating on layers of a neural network, each processing unit (e.g., core) can be active on a fixed subset of feature map segments (of one layer or multiple layers) at a given point in time. Parts of different layers may be processed on a single processing unit in a time-interleaved fashion. In some examples, for each active layer, segments are processed sequentially. If (per layer) all segments have the same size, corresponding decompressed segments have approximately the same size. In this way, the processing system 100 may manage memory by reserving a fixed amount of memory per active layer.

It will be appreciated that one or more other operations may be performed prior to compression and storage of the updated values. For example, an activation function may be applied to the updated values. For example, this may be done for purposes of determining whether a particular neuron should generate and transmit an output delta state (see, for example, the diagram 300 of FIG. 3). As mentioned, however, where a neural network involves spiking or firing, compression and storage of updated feature map values may occur irrespective of whether neurons have spiked or fired. The method 400 concludes at closing loop element 416. The updated (if at all), compressed, and stored values of all relevant feature map segments then represent the updated extrinsic state memory of the neural network (after processing of the current input frame). These values can then be used to process a subsequent input frame and operations in the method 400 may be repeated mutatis mutandis.

It is noted that the sequence of operations (such as the operations 404 to 414 of FIG. 4) performed with respect to feature map segments of a given feature map need not be performed strictly sequentially on a segment-by-segment basis. For example, the decompression operation (e.g., operation 404) may be performed ahead of time. This may, for instance, be effected by performing the decompression of a particular feature map segment (e.g., row) while the previous feature map segment (e.g., previous row in the same feature map) is still being updated. As another example, the compression operation (e.g., operation 410) may be applied after a next feature map segment is already being decompressed, updated, or otherwise handled.

Accordingly, in some examples, for one or more of a plurality of feature map segments, the decompression of a first set of values of the feature map segment is performed prior to completing updating, based on the current input frame, with respect to a previous feature map segment of the plurality of feature map segments (in the same feature map). In some examples, for one or more of the plurality of feature map segments, the compression of a second set of values (e.g., updated values as described above) is performed subsequent to initiating updating, based on the current input frame, with respect to a subsequent feature map segment of the plurality of feature map segments (in the same feature map).

It is noted that compression techniques may be lossy. As described elsewhere, the state memory of the neural network may be reset (e.g., periodically or based on some other reset trigger) to avoid or limit error accumulation resulting from multiple operations of data compression and decompression. Accordingly, in some examples, the method 400 may include performing such a reset operation. For example, an extrinsic state memory of a neural network, that is utilized to leverage temporal sparsity, may be reset every 15 frames, every 20 frames, every 25 frames, every 30 frames, every 35 frames, every 40 frames, every 45 frames, or every 50 frames (e.g., by resetting the value of each stateful neuron to zero or another default value).

Examples described herein therefore allow for a reduction in the amount of memory required for stateful inference. For a memory-constrained inference engine, feature map compression may be an enabler of stateful inference and associated capabilities or benefits. For example, in a video streaming use case, when successive image frames are correlated, the increment of one frame with respect to a previous frame may be sparse. When performing event-driven, stateful inference, only these sparse changes need to be taken into account during inference, and techniques described herein may facilitate reduction in memory requirements to perform such inference (e.g., allowing an edge-of-cloud device to run such inference efficiently). As another example, in an audio streaming use case, when successive audio frames are overlapping windows in a linear audio stream (e.g., in so-called “sliding-window inference”), feature maps store partial results of a previous inference. For certain inference algorithms, such as Conv-TasNet (fully-convolutional time-domain audio separation network), this may save significant “re-compute,” and result in lower latencies and savings in power consumption. Again, techniques described herein may facilitate reduction in memory requirements to perform such inference (e.g., allowing an edge-of-cloud device to run such inference efficiently).

As mentioned above, different techniques may be used to compress neuron states (e.g., feature map values) for storage between successive frames. BFP is a non-limiting example of such a technique, and will be described below. Other non-limiting examples include discrete cosine transform (DCT), decomposed FP16 (that separates exponents and mantissas), and zero-value compression.

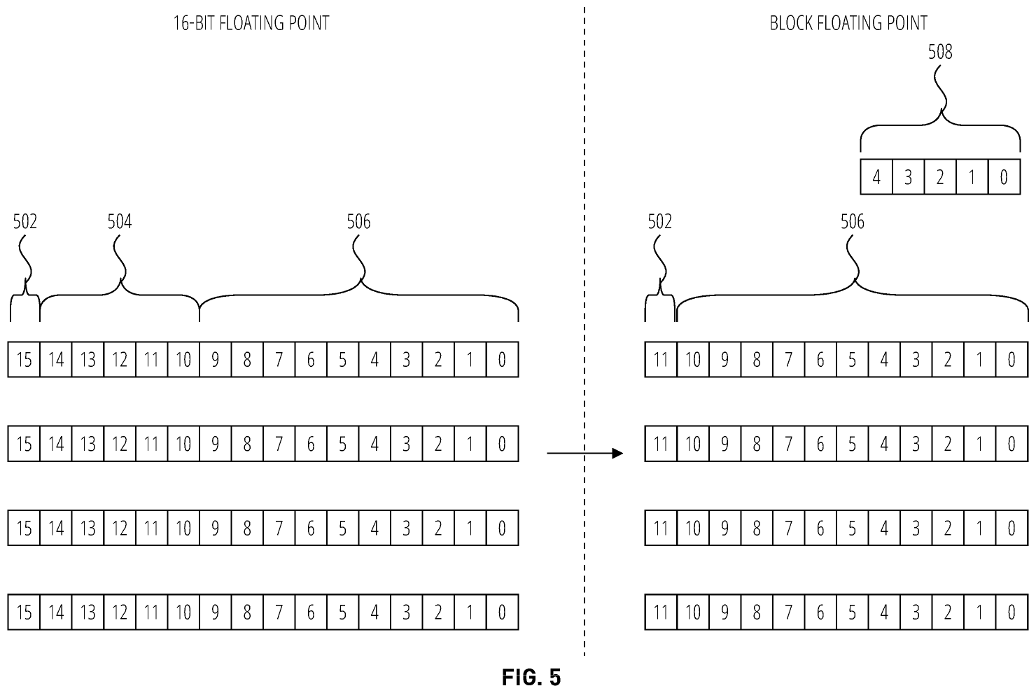

FIG. 5 is a diagrammatic illustration of BFP conversion that may be performed as a compression technique by a processing system during stateful inference, according to some examples. BFP is an example of a lossy compression technique.

The BFP format provides a way to represent a block of floating-point values, in which the blocks share a single common exponent instead of each value having its own exponent. As shown in FIG. 5, four standard FP16 format values may each have a sign 502 (1-bit), an exponent 504 (5-bit), and a mantissa 506 (10-bit). When converted to BFP, there is a single, shared exponent 508. Such exponent-sharing means that BFP may reduce the number of bits required for storing values.

In FIG. 5, the size of the mantissa 506 goes from 10-bit to 11-bit in the compression to BFP. This is the case because, in the FP16 format, the mantissa 506 has one implicit bit, which is encoded using the exponent 504. If the exponent of an FP16 value is greater than zero, the mantissa 506 is normalized to have a one as its most significant bit (MSB). This normalization makes it implicit that there is a one as MSB, which allows the FP16 format to encode it in its exponent. The BFP format cannot do such normalization as the shared exponent 508 is shared among the mantissa values. Therefore, the BFP format has to explicitly state the extra mantissa bit.

For example, when using FP16 for calculations in a neural network and also for storing calculated or updated values, the memory footprint of four values (e.g., the values in FIG. 5) is 64 bits. If storing is done in BFP format, the number of bits required for storage is (5+4×(M+1)) bits, where 0<M<12, as going beyond the number of mantissa bits found in FP16, including the implicit bit, may not be worthwhile. Therefore, the number of bits that can be saved by using the BFP format (e.g., a 2×2 block) for storage in this example is between 11 and 51, depending on the selected number of mantissa bits.

It is noted that compression parameters may be adjusted or varied, e.g., to manage the trade-off between memory savings and accuracy. For example, memory savings can be increased by reducing mantissa size in the compressed data. This may, however, come at the expense of a degree of accuracy. Conversely, mantissa size may be increased to improve accuracy while still allowing for memory savings (depending on the implementation). BFP block sizes and/or shapes may also be adjusted or varied, as described further below.

In some examples, different feature maps and/or different layers within a neural network may have different compression parameters (such as mantissa sizes or block parameters). For example, in certain layers, higher accuracy may be required, in which case mantissa size can be increased for those layers, while in other layers mantissa size can be reduced to provide memory savings.

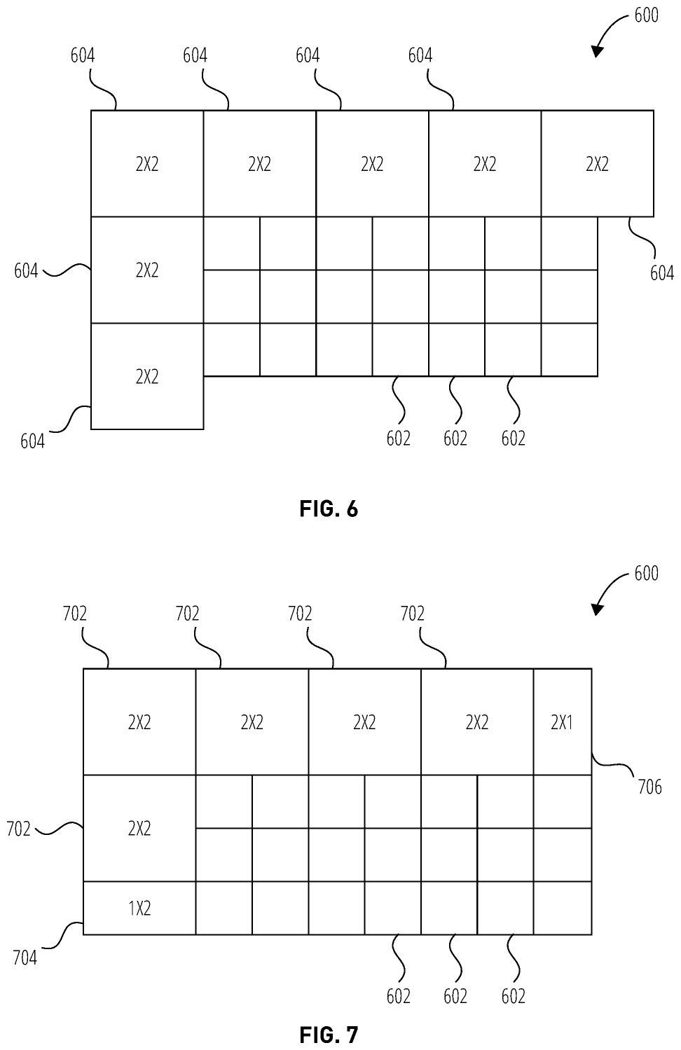

Different block shapes and block assignment techniques may be employed when using BFP compression. FIG. 6 is a diagrammatic illustration of a block assignment technique for BFP compression of feature map values that utilizes homogenous partitioning, according to some examples. FIG. 6 shows a feature map 600 that has a plurality of values 602 (e.g., neuron states). It is noted that blocks would typically cover the entire feature map 600, and the feature map 600 is shown only partially covered for illustrative purposes (e.g., to show the values 602).

In the example of FIG. 6, memory is allocated such that blocks are assigned in a homogenous manner. In other words, allocated space is a multiple of a specific block shape. In the feature map 600, for example, blocks 604 are all 2×2 blocks (covering up to four feature map values). However, in the technique of FIG. 6, at least in some cases, only parts of certain blocks may be used (as illustrated by the bottom left block 604 and the top right block 604 in FIG. 6).

In some examples, allocation is performed in a static manner based on a synchronization scheme. Feature map segments that are alive at mutually exclusive times are statically mapped to the same memory. Allocated memory should be large enough to hold the block/s for a single segment, and the number of instances thereof may depend on the number of simultaneously live segments.

FIG. 7 is a diagrammatic illustration of a block assignment technique for BFP compression of feature map values that utilizes heterogenous partitioning, according to some examples. FIG. 7 shows the same feature map 600 as shown in FIG. 6. Again, it is noted that blocks would typically cover the entire feature map 600, and the feature map 600 is shown only partially covered for illustrative purposes.

In the example of FIG. 7, however, the feature map 600 has blocks 702 (2×2 blocks similar to the blocks 604 of FIG. 6), as well as blocks of other shapes, including a block 704 (1×2 block) and a block 706 (2×1 block) assigned thereto in a heterogenous manner. When performing heterogenous allocation, blocks at the end of a row, column, or channel may have a different shape than other blocks (as shown in FIG. 7). In other words, “left-over values” may be stored in smaller blocks than other values. It may not always be possible to partition a feature map into blocks of fixed dimensions, and heterogenous partitioning techniques may be used to address this issue.

Heterogenous block assignment may be more memory efficient, but may require additional logic for block indexing, and an optimal technique may depend on the implementation. In some examples, allocation of memory is decided during an offline phase (e.g., at compile time). Rules may be implemented to enable the processing system 100 to handle certain “edge cases” during decompression. For example, a core is aware of the width of a segment, and therefore, the core can be configured to determine, when nearing a final block, whether it is a “complete block” (e.g., 2×2) or a “partial” block (e.g., 1×2). As an example, the core may be configured to perform assignment or partitioning for such “edge cases” in an adaptive manner based on the coordinates of a pixel being processed and the shape of a current feature map (both known to the processing system).

It is noted that blocks may not only have various or adjusted height and width (x, y) dimensions, but also depth/channel (2) dimensions in the case of multi-channel maps.

Fewer values in a block may mean fewer opportunities for compression errors. On the other hand, decreasing block size may decrease compression ratio. BFP may perform better when used on blocks where values have a similar exponent. For example, when the exponents of values within a block have a high variance, there may be a higher compression error. For example, assuming that in a given image there is a better correlation between horizontal pixels than vertical pixels, then the processing system 100 may select blocks with a higher width than height dimension. It is noted that feature map segments used for segment-wise updates need not necessarily correspond with blocks used for BFP compression (e.g., the feature map segments need not necessarily be the same size and/or shape as the BFP blocks).

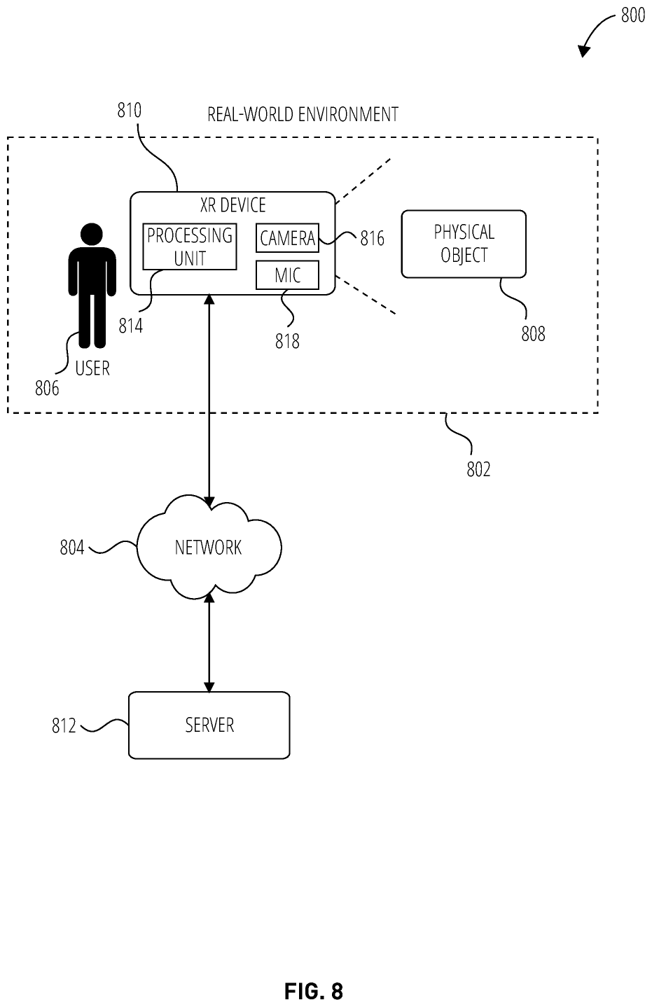

Referring now to FIG. 8, a diagram is shown to illustrate a network environment 800 suitable for operating an XR device 810, according to some examples. The network environment 800 includes an XR device 810 and a server 812, communicatively coupled to each other via a network 804. The server 812 may be part of a network-based system. For example, the network-based system may be or include a cloud-based server system that provides additional information, such as virtual content (e.g., three-dimensional models of virtual objects, or augmentations to be applied as virtual overlays onto images depicting real-world scenes) to the XR device 810.

The term “XR” refers to “extended reality,” which covers augmented reality (AR) and/or virtual reality (VR). The term “AR” refers to an interactive experience of a real-world environment where physical objects or environments that reside in the real world are “augmented” or enhanced by computer-generated digital content (also referred to as virtual content or synthetic content). An AR device can enable a user to observe a real-world scene while simultaneously seeing virtual content that may be aligned to objects, images, or environments in the field of view of the AR device. AR can also refer to a system that enables a combination of real and virtual worlds, real-time interaction, and three-dimensional (3D) representation of virtual and real objects. A user of an AR system can perceive virtual content that appears to be attached or interacting with a real-world physical object, e.g., overlaid on the real world.

The term “VR” refers to a simulation experience of a virtual world environment that is distinct from the real-world environment. Computer-generated digital content is displayed in the virtual world environment. A VR device may block out the field of view of the user with virtual content that is displayed based on a position and orientation of the VR device. VR also refers to a system that enables a user of a VR system to be completely immersed in the virtual world environment and to interact with virtual objects presented in the virtual world environment. In general, AR and VR devices are referred to as XR devices. A further device is based on mixed reality “MR” which typically represents a hybrid of AR and VR, in which world facing cameras acquire images that are merged with virtual content to be displayed on a VR device. An AR device is generally transparent or see through, while VR and MR devices are opaque or non-see through. The term “XR” may thus also refer to MR.

Referring again to FIG. 8, a user 806 operates the XR device 810. The user 806 may be a human user (e.g., a human being), a machine user (e.g., a computer configured by a software program to interact with the XR device 810), or any suitable combination thereof (e.g., a human assisted by a machine or a machine supervised by a human). The user 806 is not part of the network environment 800 but is associated with the XR device 810.

The XR device 810 may be a computing device with a display such as a smartphone, a tablet computer, or a wearable computing device (e.g., watch or glasses). The computing device may be hand-held or may be removably mounted to a head of the user 806. The XR device 810 includes various components, including a processing unit 814 and a camera 816. In some examples, the display may be a screen that displays what is captured with the camera 816 of the XR device 810. In other examples, the display of the device may be transparent or semi-transparent such as in lenses of wearable computing glasses. In other examples, the display may be a transparent display such as a windshield of a car, plane, or truck (e.g., as part of a heads-up display system). In another example, the display may be non-transparent and wearable by the user to cover the field of vision of the user.

The user 806 operates an application of the XR device 810. The application may include an AR application configured to provide the user 806 with an experience triggered or enhanced by a physical object 808, such as a two-dimensional physical object (e.g., a picture or navigation prompt), a three-dimensional physical object (e.g., a statue), a location (e.g., a factory), or references (e.g., perceived corners of walls or furniture, or Quick Response (QR) codes) in the real-world environment 802. For example, the user 806 may point the camera 816 of the XR device 810 to capture an image of the physical object 808 and a virtual overlay may be presented over the physical object 808 via the display. Certain experiences may also be triggered, enhanced, or controlled by a hand of the user 806. Accordingly, it will be appreciated that the physical object 808 or real-world object being tracked or detected by the XR device 810 may be the hand of the user 806.

To allow the user 806 to have an AR experience and/or interact with virtual objects, the XR device 810 may detect the positions and movements of objects, including, for example, one or both hands of the user 806. The XR device 810 may use hand positions, shapes, or movements to determine the user's intentions in manipulating virtual objects. To this end, the XR device 810 includes tracking components implemented using the processing unit 814. The tracking components may track the pose (e.g., position and orientation) of the XR device 810 relative to the real-world environment 802 using image sensors (e.g., the camera 816 and/or other image sensors), inertial sensors (e.g., a gyroscope, accelerometer, or the like), wireless sensors (e.g., Bluetooth™ or Wi-Fi sensors), a Global Positioning System (GPS) sensor, and/or an audio sensor (e.g., the microphone 818 shown in FIG. 4).

The processing unit 814 may be used to generate tracking estimates or predictions, e.g., to predict the location or pose of a tracked object. The XR device 810 may utilize one or more object tracking machine learning models or one or more object detection machine learning models for this purpose. A specific, non-limiting example of a machine learning model is a trained neural network for gesture recognition.

In this context, a machine learning model may comprise a neural network trained on suitable training data to identify and/or track objects in one or more frames captured by the XR device 810. As mentioned, in some examples, the components of the processing system 100 of FIG. 1 are integrated into a single processing unit. The processing unit 814 of the XR device 810 may comprise an event-driven processing system, such as the processing system 100. Accordingly, the XR device 810 is a (non-limiting) example of a computing device in which the processing system 100 can be implemented. The processing system 100 may, for example, facilitate real-time processing of sensor data captured by the XR device 810, such as image data captured using the camera 816 or audio data captured using the microphone 818.

In some examples, the XR device 810 executes neural networks by exploiting temporal sparsity in stateful inference. The processing unit 814 may execute operations described herein to reduce a memory footprint associated with stateful inference. This may also result in improved battery life or lower latency. The XR device 810 may, for example, apply such techniques in the processing of image data or audio data (e.g., to process and update feature maps that represent image features or to process and update feature maps that represent sound features).

In some examples, the server 812 may be used to perform certain detection and tracking based on sensor data (e.g., image and depth data) from the XR device 810. Accordingly, the XR device 810 or the server 812, or both, can perform image processing, object detection and/or object tracking functions based on images captured by the XR device 810 and one or more parameters internal or external to the XR device 810. Accordingly, the server 812 may also, in some examples, benefit from employing techniques for memory-efficient stateful inference as described herein. In some examples, the server 812 may include or be coupled to a processing system such as the processing system 100 of FIG. 1.

The network 804 may be any network that enables communication between or among machines (e.g., server 812), databases, and devices (e.g., XR device 810). Accordingly, the network 804 may be a wired network, a wireless network (e.g., a mobile or cellular network), or any suitable combination thereof. The network 804 may include one or more portions that constitute a private network, a public network (e.g., the Internet), or any suitable combination thereof.

### EXAMPLES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method for reducing memory footprint in stateful inference of a neural network, the method performed by one or more processors and comprising: accessing a plurality of feature map segments, each feature map segment of the plurality of feature map segments comprising a first set of values stored in a compressed manner, wherein the first sets of values at least partially represent a state memory of the neural network after processing a previous input frame; and for each feature map segment of the plurality of feature map segments: decompressing the first set of values, storing the decompressed first set of values, updating at least a subset of the decompressed first set of values based on a current input frame to obtain a second set of values, compressing the second set of values, storing the compressed second set of values, and releasing memory resources used to store the decompressed first set of values, wherein the second sets of values at least partially represent the state memory of the neural network after processing of the current input frame.

In Example 2, the subject matter of Example 1 includes, wherein the first set of values and the second set of values are compressed using block floating point (BFP).

In Example 3, the subject matter of any of Examples 1-2 includes, wherein the neural network comprises a plurality of layers, first compression parameters are applied to feature map segments of the plurality of feature map segments that are in a first subset of the plurality of layers, and second compression parameters are applied to feature map segments of the plurality of feature map segments that are in a second subset of the plurality of layers, the first compression parameters being different than the second compression parameters.

In Example 4, the subject matter of any of Examples 1-3 includes, wherein the neural network comprises a plurality of feature maps, each feature map comprising one or more of the plurality of feature map segments, first compression parameters are applied to feature map segments of the plurality of feature map segments that are in a first subset of the plurality of feature maps, and second compression parameters are applied to feature map segments of the plurality of feature map segments that are in a second subset of the plurality of feature maps, the first compression parameters being different than the second compression parameters.

In Example 5, the subject matter of any of Examples 1-4 includes, wherein the one or more processors are configured to reset the state memory of the neural network in response to detecting a reset trigger.

In Example 6, the subject matter of any of Examples 1-5 includes, wherein the updating performed based on the current input frame to obtain the second set of values comprises: applying one or more accumulations that result from the current input frame, the one or more accumulations being determined based on differences between the current input frame and the previous input frame.

In Example 7, the subject matter of any of Examples 1-6 includes, wherein the updating performed based on the current input frame to obtain the second set of values comprises: initializing uncompressed memory resources with the first set of values; and after initializing the uncompressed memory resources with the first set of values, applying one or more accumulations that result from the current input frame.

In Example 8, the subject matter of any of Examples 1-7 includes, wherein the updating performed based on the current input frame to obtain the second set of values comprises: initializing uncompressed memory resources with zero values; applying, to the zero values, one or more first accumulations that result from the current input frame; and after applying the one or more first accumulations, applying one or more second accumulations based on the first set of values.

In Example 9, the subject matter of any of Examples 1-8 includes, wherein, for one or more of the plurality of feature map segments, the decompression of the first set of values of the feature map segment is performed prior to completing the updating, based on the current input frame, with respect to a previous feature map segment of the plurality of feature map segments, the previous feature map segment being in a same feature map.

In Example 10, the subject matter of any of Examples 1-9 includes, wherein, for one or more of the plurality of feature map segments, the compression of the second set of values is performed subsequent to initiating the updating, based on the current input frame, with respect to a subsequent feature map segment of the plurality of feature map segments, the subsequent feature map segment being in a same feature map.

In Example 11, the subject matter of any of Examples 1-10 includes, wherein the previous input frame and the current input frame are image data frames or audio data frames.

In Example 12, the subject matter of any of Examples 1-11 includes, wherein the neural network comprises a plurality of feature maps, each feature map comprising a plurality of the feature map segments.

In Example 13, the subject matter of Example 12 includes, wherein the feature map segments of each feature map are respective zones within the feature map, the feature map being divided into zones based on a predetermined segmentation rule.

In Example 14, the subject matter of any of Examples 1-13 includes, for each feature map segment of the plurality of feature map segments: prior to the compression and storage of the second set of values, applying an activation function to one or more values in the second set of values.

In Example 15, the subject matter of Examples 1-14 includes, using the second sets of values in processing of a subsequent input frame.

In Example 16, the subject matter of Example 15 includes, wherein using of the second sets of values in the processing of the subsequent input frame comprises: for each feature map segment of the plurality of feature map segments: decompressing the second set of values associated with the feature map segment, storing the decompressed second set of values, updating at least a subset of the decompressed second set of values based on the subsequent input frame to obtain a third set of values, compressing the third set of values, storing the compressed third set of values, and releasing memory resources used to store the decompressed second set of values, wherein the third sets of values at least partially represent the state memory of the neural network after processing of the subsequent input frame.

In Example 17, the subject matter of any of Examples 1-16, wherein the state memory is an extrinsic state memory.

In Example 18, the subject matter of any of Examples 1-16, wherein the state memory is an intrinsic state memory.

Example 19 is a processing system comprising one or more processors configured to perform operations for reducing memory footprint in stateful inference of a neural network, the operations comprising: accessing a plurality of feature map segments, each feature map segment of the plurality of feature map segments comprising a first set of values stored in a compressed manner, wherein the first sets of values at least partially represent a state memory of the neural network after processing a previous input frame; and for each feature map segment of the plurality of feature map segments: decompressing the first set of values, storing the decompressed first set of values, updating at least a subset of the decompressed first set of values based on a current input frame to obtain a second set of values, compressing the second set of values, storing the compressed second set of values, and releasing memory resources used to store the decompressed first set of values, wherein the second sets of values at least partially represent the state memory of the neural network after processing of the current input frame.

In Example 20, the subject matter of Example 19 includes, wherein the one or more processors comprises an event-based neural processor, the event-based neural processor comprising a plurality of processing clusters configured to process at least a subset of the feature map segments in parallel.

In Example 21, the subject matter of any of Examples 19-20, wherein the state memory is an extrinsic state memory.

In Example 22, the subject matter of any of Examples 19-20, wherein the state memory is an intrinsic state memory.

Example 23 is an extended reality (XR) device comprising the processing system of any of Examples 19-22.

Example 24 is a non-transitory machine-readable storage medium that includes, instructions that, when executed by one or more processors, cause the one or more processors to perform operations for reducing memory footprint in stateful inference of a neural network, the operations comprising: accessing a plurality of feature map segments, each feature map segment of the plurality of feature map segments comprising a first set of values stored in a compressed manner, wherein the first sets of values at least partially represent a state memory of the neural network after processing a previous input frame; and for each feature map segment of the plurality of feature map segments: decompressing the first set of values, storing the decompressed first set of values, updating at least a subset of the decompressed first set of values based on a current input frame to obtain a second set of values, compressing the second set of values, storing the compressed second set of values, and releasing memory resources used to store the decompressed first set of values, where in the second sets of values at least partially represent the state memory of the neural network after processing of the current input frame.

In Example 25, the subject matter of Example 24, wherein the state memory is an extrinsic state memory.

In Example 26, the subject matter of Example 24, wherein the state memory is an intrinsic state memory.

Example 27 is at least one machine-readable medium including instructions that, when executed by processing circuitry, cause the processing circuitry to perform operations to implement of any of Examples 1-26.

Example 28 is an apparatus comprising means to implement of any of Examples 1-26.

Example 29 is a system to implement of any of Examples 1-26.

Example 30 is a method to implement of any of Examples 1-26.

### Conclusion

It is noted that compression of feature map values, as described herein, is distinct from various other techniques such as feature compression, network compression, and model compression. Feature compression, network compression, and model compression generally refer to compression of a machine learning model, or parts thereof, and do not apply to compression of the state of a neural network.

It is further noted that compression of feature map values, as described herein, relates to inter-frame compression as opposed to intra-frame compression. For example, in intra-frame compression, techniques may be used to compress all feature maps of a single layer and subsequently hand these compressed maps over to a subsequent layer for processing. However, such processing relates to the same frame and is thus intra-frame compression. In contrast, techniques described herein are used in stateful inference where the state of the neural network is stored for use with respect to a subsequent frame, hence the term inter-frame compression.

The technique of inter-frame compression may be applied to internal representations (e.g., feature maps) within a neural network to reduce the memory footprint of storing these representations across successive frames. Unlike intra-frame compression, which may focus on compressing elements within the same frame or same inference operation to reduce bandwidth or storage for that single inference, inter-frame compression specifically targets the temporal aspect of data by compressing the feature maps that represent the state of the network between frames. This technique may leverage temporal redundancy present in sequences of frames, such as consecutive video frames or audio samples, to apply compression more effectively.

Although specific examples are described herein, it will be evident that various modifications and changes may be made to these examples without departing from the broader spirit or scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the subject matter may be referred to herein, individually or collectively, by the term “example” or merely for convenience and without intending to voluntarily limit the scope of this application to any single example or concept if more than one is in fact disclosed. Thus, although specific examples have been illustrated and described herein, it should be appreciated that another arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

As used in this disclosure, the term “machine learning model” (or simply “model”) may refer to a single, standalone model, or a combination of models. The term may also refer to a system, component or module that includes a machine learning model together with one or more supporting or supplementary components that do not necessarily perform machine learning tasks.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another, or may be combined in various ways. All possible combinations and subcombinations are intended to fall within the scope of this disclosure. In addition, certain method or process blocks or operations may be omitted in some implementations.

Any biometric or other personally identifiable information (PII) collected by biometric or other data capturing components is captured and stored only with user approval and deleted on user request. Further, such data may be used for very limited purposes, such as identification verification. To ensure limited and authorized use of biometric and other PII, access to this data is restricted to authorized personnel only, if at all. The data is not shared or sold to any third party without the explicit consent of the user. In addition, appropriate technical and organizational measures are implemented to ensure the security and confidentiality of this sensitive information.

Although some examples (e.g., those depicted in the drawings) include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a

communications network to obtain resources from one or more server systems or other client devices. A client device may be, but is not limited to, a mobile phone, desktop computer, laptop, portable digital assistant (PDA), smartphone, tablet, ultrabook, netbook, laptop, multi-processor system, microprocessor-based or programmable consumer electronics, game console, set-top box, or any other communication device that a user may use to access a network.

“Communication network” refers, for example, to one or more portions of a

network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, Application Programming Interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor, a group of processors or part of a processor) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporancously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors (or part thereof) being an example of hardware. For example, at least some of the operations of a method may be performed by one or more processors or processor-implemented components. At least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Processor” may refer to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a CPU, a Reduced Instruction Set Computing (RISC) Processor, a Complex Instruction Set Computing (CISC) Processor, a GPU, a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor may be a multi-core processor having two or more independent processors (sometimes referred to as “cores”) that may execute instructions contemporaneously. Multi-core processors may contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor may be emulated in software, running on a physical processor, as a virtual processor or virtual circuit. The virtual processor may behave like an independent processor but is implemented in software rather than hardware. Accordingly, unless a specific processor architecture, hardware, design, and/or structure is specified or is clear from the context, the term “processor,” “processing system,” or the like, should be interpreted broadly herein.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a manner as to encode information in the signal. The terms “transmission medium” and “signal medium” mean the same thing and may be used interchangeably in this disclosure.

“User device” refers, for example, to a device accessed, controlled, or owned by a user and with which the user interacts to perform an action, or interaction on the user device, including an interaction with other users or computer systems. A user device may, for example, be one or more of the client devices listed above.

What is claimed is:

1. A method for reducing memory footprint in stateful inference of a neural network, the method performed by one or more processors and comprising:
accessing a plurality of feature map segments, each feature map segment of the plurality of feature map segments comprising a first set of values stored in a compressed manner, wherein the first sets of values at least partially represent an extrinsic state memory of the neural network after processing a previous input frame; and
for each feature map segment of the plurality of feature map segments:
decompressing the first set of values,
storing the decompressed first set of values,
updating at least a subset of the decompressed first set of values based on a current input frame to obtain a second set of values,
compressing the second set of values,
storing the compressed second set of values, and
releasing memory resources used to store the decompressed first set of values,
wherein the second sets of values at least partially represent the extrinsic state memory of the neural network after processing of the current input frame.

2. The method of claim 1, wherein the first set of values and the second set of values are compressed using block floating point (BFP).

3. The method of claim 1, wherein the neural network comprises a plurality of layers, first compression parameters are applied to feature map segments of the plurality of feature map segments that are in a first subset of the plurality of layers, and second compression parameters are applied to feature map segments of the plurality of feature map segments that are in a second subset of the plurality of layers, the first compression parameters being different than the second compression parameters.

4. The method of claim 1, wherein the neural network comprises a plurality of feature maps, each feature map comprising one or more of the plurality of feature map segments, first compression parameters are applied to feature map segments of the plurality of feature map segments that are in a first subset of the plurality of feature maps, and second compression parameters are applied to feature map segments of the plurality of feature map segments that are in a second subset of the plurality of feature maps, the first compression parameters being different than the second compression parameters.

5. The method of claim 1, wherein the one or more processors are configured to reset the extrinsic state memory of the neural network in response to detecting a reset trigger.

6. The method of claim 1, wherein the updating performed based on the current input frame to obtain the second set of values comprises:
applying one or more accumulations that result from the current input frame, the one or more accumulations being determined based on differences between the current input frame and the previous input frame.

7. The method of claim 1, wherein the updating performed based on the current input frame to obtain the second set of values comprises:
initializing uncompressed memory resources with the first set of values; and
after initializing the uncompressed memory resources with the first set of values, applying one or more accumulations that result from the current input frame.

8. The method of claim 1, wherein the updating performed based on the current input frame to obtain the second set of values comprises:
initializing uncompressed memory resources with zero values;
applying, to the zero values, one or more first accumulations that result from the current input frame; and
after applying the one or more first accumulations, applying one or more second accumulations based on the first set of values.

9. The method of claim 1, wherein, for one or more of the plurality of feature map segments, the decompression of the first set of values of the feature map segment is performed prior to completing the updating, based on the current input frame, with respect to a previous feature map segment of the plurality of feature map segments, the previous feature map segment being in a same feature map.

10. The method of claim 1, wherein, for one or more of the plurality of feature map segments, the compression of the second set of values is performed subsequent to initiating the updating, based on the current input frame, with respect to a subsequent feature map segment of the plurality of feature map segments, the subsequent feature map segment being in a same feature map.

11. The method of claim 1, wherein the previous input frame and the current input frame are image data frames or audio data frames.

12. The method of claim 1, wherein the neural network comprises a plurality of feature maps, each feature map comprising a plurality of the feature map segments.

13. The method of claim 12, wherein the feature map segments of each feature map are respective zones within the feature map, the feature map being divided into zones based on a predetermined segmentation rule.

14. The method of claim 1, further comprising, for each feature map segment of the plurality of feature map segments:
prior to the compression and storage of the second set of values, applying an activation function to one or more values in the second set of values.

15. The method of claim 1, further comprising:
using the second sets of values in processing of a subsequent input frame.

16. The method of claim 15, wherein using of the second sets of values in the processing of the subsequent input frame comprises:
for each feature map segment of the plurality of feature map segments:
decompressing the second set of values associated with the feature map segment,
storing the decompressed second set of values,
updating at least a subset of the decompressed second set of values based on the subsequent input frame to obtain a third set of values,
compressing the third set of values,
storing the compressed third set of values, and
releasing memory resources used to store the decompressed second set of values,
wherein the third sets of values at least partially represent the extrinsic state memory of the neural network after processing of the subsequent input frame.

17. A processing system comprising one or more processors configured to perform operations for reducing memory footprint in stateful inference of a neural network, the operations comprising:
accessing a plurality of feature map segments, each feature map segment of the plurality of feature map segments comprising a first set of values stored in a compressed manner, wherein the first sets of values at least partially represent an extrinsic state memory of the neural network after processing a previous input frame; and
for each feature map segment of the plurality of feature map segments:
decompressing the first set of values,
storing the decompressed first set of values,
updating at least a subset of the decompressed first set of values based on a current input frame to obtain a second set of values,
compressing the second set of values,
storing the compressed second set of values, and
releasing memory resources used to store the decompressed first set of values,
wherein the second sets of values at least partially represent the extrinsic state memory of the neural network after processing of the current input frame.

18. The processing system of claim 17, wherein the one or more processors comprises an event-based neural processor, the event-based neural processor comprising a plurality of processing clusters configured to process at least a subset of the feature map segments in parallel.

19. An extended reality (XR) device comprising the processing system of claim 17.

20. A non-transitory machine-readable storage medium that includes instructions that, when executed by one or more processors, cause the one or more processors to perform operations for reducing memory footprint in stateful inference of a neural network, the operations comprising:
accessing a plurality of feature map segments, each feature map segment of the plurality of feature map segments comprising a first set of values stored in a compressed manner, wherein the first sets of values at least partially represent an extrinsic state memory of the neural network after processing a previous input frame; and
for each feature map segment of the plurality of feature map segments:
decompressing the first set of values,
storing the decompressed first set of values,
updating at least a subset of the decompressed first set of values based on a current input frame to obtain a second set of values,
compressing the second set of values,
storing the compressed second set of values, and
releasing memory resources used to store the decompressed first set of values,
wherein the second sets of values at least partially represent the extrinsic state memory of the neural network after processing of the current input frame.
